(19) United States
(12) Patent Application Publication
(10) Pub. No.: US 2017/0254376 A1
(43) Pub. Date: Sep. 7, 2017

(54) SELECTABLE CLUTCH MODULE ACTUATOR USING A SINGLE HYDRAULIC FEED TO ACHIEVE THREE OR MORE MODES

(71) Applicant: BorgWarner Inc., Auburn Hills, MI (US)

(72) Inventors: Calahan B. Campton, Royal Oak, MI (US); Christopher A. Spangler, Rochester Hills, MI (US); Jason M. Nienstedt, Macomb, MI (US)

(21) Appl. No.: 15/443,559

(22) Filed: Feb. 27, 2017

Related U.S. Application Data
(60) Provisional application No. 62/302,041, filed on Mar. 1, 2016.

(51) Int. Cl. F16D 41/16; F16D 25/08; F16D 23/12; F16D 48/02

(52) U.S. Cl. CPC F16D 41/16; F16D 25/14; F16D 25/088; F16D 23/12; F16D 2023/123

(57) ABSTRACT

The actuating mechanism for the selectable clutch module may include an actuator housing that defines an actuator chamber. At least one piston may be disposed within the actuator chamber and configured to move between at least a first piston position and a second piston position. An armature may be attached to the piston and a cam may be operatively associated with the armature. The actuating mechanism may further include an actuator spring disposed within the actuator chamber and positioned between the piston and an end of the actuator housing. A hydraulic pressure may be supplied to the actuating mechanism to move the piston between the at least first piston position and the second piston position.

### CROSS-REFERENCE TO RELATED APPLICATION

This application is an International Patent Application claiming priority under 35 U.S.C. §119(e) to U.S. Provisional Patent Application No. 62/302,041, filed on Mar. 1, 2016.

### FIELD OF THE DISCLOSURE

The present disclosure is generally related to clutches for automotive transmissions, and more particularly, relates to selectable clutch assemblies employed in the operation of such transmissions.

### BACKGROUND OF THE DISCLOSURE

Some machines such as, automobiles, trucks, vans, agriculture equipment, construction equipment, or the like, may be equipped with a selectable clutch actuation device. Moreover, such machines may include an internal combustion engine containing a rotatable crankshaft configured to transfer power from the engine through a driveshaft in order to propel the machine. Furthermore, a transmission may be positioned between the internal combustion engine and the driveshaft to selectively control torque and speed ratios between the crankshaft and driveshaft.

In the case of a manually operated transmission, a manually operated clutch may be positioned between the internal combustion engine and the transmission to selectively engage and disengage the crankshaft from the driveshaft in order to facilitate shifting through the available transmission gear ratios. Alternatively, in an automatically operated transmission, a plurality of automatically actuated clutch units may be adapted to dynamically shift through the available gear ratios without requiring operator intervention. In some embodiments, the plurality of clutch units or clutch modules may be incorporated within automatic transmissions to facilitate the automatic shifting through the gear ratios.

Moreover, the transmission may incorporate numerous sets of gears and the various gears may be structurally comprised of sun gears, intermediate gears, such as planet or pinion gears supported by carriers, and outer ring gears. Moreover, specific transmission clutches may be associated with specific sets of the selectable gears within the transmission to facilitate the desired ratio changes.

An exemplary automatic transmission clutch module that is associated with first (low) and reverse gear ratios may be positioned near the front of the transmission and closely adjacent to the engine crankshaft. The clutch may have a driving member and a driven member disposed circumferentially about the driving member. Furthermore, the driving and driven members may be configured to operate in multiple modes. In one non-limiting example, the driving member may be drivingly rotatable in only one direction. Alternatively or additionally, the driving member may be drivingly rotatable in a plurality of directions; however other modes and rotations may be possible. Moreover, the driving member may be selectively locked to the driven member via an engagement mechanism such as a roller, a sprag, a pawl or other known engagement mechanisms. The rotation of the driving member may be effective to directly transfer rotational motion from the engine to the driveline.

In some transmission systems, the driven member may be fixed to an internal case or housing of an associated planetary member of the automatic transmission. Under such circumstances, in a first configurational mode the driving member may need to be adapted to drive in one rotational direction, but freewheel in the opposite direction, in a condition referred to as overrunning. Those skilled in the art will appreciate that overrunning may be particularly desirable under certain operating states, such as when a machine is traveling downhill or coasting. Under such condition, the driven member may occasionally have a tendency to rotate faster than its associated driving member. Allowing the driving member to overrun the driven member may help provide protection against damage to the engine and/or transmission components.

In a second non-limiting mode, such as when a machine may be in reverse gear, the engagement mechanisms may be adapted for actively engaging in both rotational directions of the driving member, thus not allowing for an overrunning condition in either direction.

Automatic transmissions may include a plurality of gear sets to accommodate multiple gear ratios, and therefore the reliability of actuators used for automatically switching clutch modules between and/or among various available operating modes is a consistent design concern. As a result, much effort has been directed to finding ways to assure actuator reliability at competitive costs.

### SUMMARY OF THE DISCLOSURE

In accordance with one aspect of the present disclosure an actuating mechanism for a selectable clutch module is disclosed. The actuating mechanism may include an actuator housing which defines an actuator chamber and a piston disposed within the actuator chamber. The piston may be slidably engaged with a first lateral sidewall and a second lateral sidewall of the actuator housing such that the piston is configured to move along the first and second lateral sidewalls between at least a first piston position and a second piston position. Furthermore, an armature may be fixedly attached to a first surface of the piston such that the armature is configured to respond to a movement of the piston. A cam may be operatively associated with the armature. An actuator spring may be disposed within the actuator chamber and the actuator spring may be positioned between the first surface of the piston and a first end of the actuator housing. Moreover, the actuating mechanism may include a hydraulic opening formed in the actuator housing and the hydraulic opening may extending through the actuator housing into the actuator chamber and the hydraulic opening may be positioned at a second end of the actuator housing. Additionally, a hydraulic pressure may be supplied to the actuating mechanism through the hydraulic opening and the hydraulic pressure may be configured to act on a second surface of the piston such that the piston moves between the at least first piston position and the second piston position.

In accordance with another aspect of the present disclosure an additional actuating mechanism for a selectable clutch module is disclosed. The actuating mechanism may include an actuator housing defining an actuator chamber and a first piston and a second piston disposed within the actuator chamber. The first piston and the second piston may be slidably engaged with a first lateral sidewall and a second lateral sidewall of the actuator housing. The first piston may be configured to move along the first and second lateral sidewalls between at least a first piston first position and a first piston second positon. The second piston may be configured to move in an opposite direction as the first piston along the first lateral sidewall and the second lateral sidewall between at least a second piston first position and a second piston second position. The actuating mechanism may further include a first armature fixedly attached to a first surface of the first piston such that the first armature is configured to respond to a movement of the first piston. Additionally, a second armature may be fixedly attached to a first surface of the second piston such that the second armature is configured to respond to a movement of the second piston. Moreover, a first cam may be operatively associated with the first armature and a second cam may be operatively associated with the second armature. A first actuator spring may be disposed within the actuator chamber and the first actuator spring may be positioned between the first surface of the first piston and a first axial end of the actuator housing. Furthermore, a second actuator spring may be disposed within the actuator chamber and the second actuator spring may be positioned between the first surface of the second piston and a second axial end of the actuator housing. A hydraulic opening may be formed in the actuator housing and the hydraulic opening may extend through the actuator housing into the actuator chamber and the hydraulic opening may be positioned between the first piston and the second piston. The actuating mechanism may further include a hydraulic pressure being supplied to the actuator chamber through the hydraulic opening and the hydraulic pressure is configured to act on a second surface of the first piston and a second surface of the second piston to move each of the first piston and the second piston.

These and other aspects and features will be better understood when reading the following detailed description in conjunction with the accompanying drawings.

### BRIEF DESCRIPTION OF THE DRAWINGS

For further understanding of the disclosed concepts and embodiments, reference may be made to the following detailed description, read in connection with the drawings, wherein like elements are numbered alike and in which:

FIG. 1 is a sectional side view of a selectable clutch assembly constructed in accordance with the present disclosure;

FIG. 2 is an enlarged view of a portion of the selectable clutch assembly of FIG. 1 constructed in accordance with the present disclosure;

FIG. 3 is an enlarged view of a portion of another embodiment of the selectable clutch assembly of FIG. 1 constructed in accordance with the present disclosure;

FIG. 4 is an enlarged view of a portion of another embodiment of the selectable clutch assembly of FIG. 1 constructed in accordance with the present disclosure;

FIG. 5 is a schematic of an actuator mechanism of the selectable clutch module constructed in accordance with the present disclosure;

FIG. 6 is a schematic of another embodiment of the actuator mechanism of FIG. 5 constructed in accordance with the present disclosure;

FIG. 7 is a schematic of another embodiment of the actuator mechanism of FIG. 5 constructed in accordance with the present disclosure;

FIG. 8 is a schematic of another embodiment of the actuator mechanism of the selectable clutch module constructed in accordance with the present disclosure;

FIG. 9 is a schematic of another embodiment of the actuator mechanism of FIG. 8 constructed in accordance with the present disclosure;

FIG. 10 is a schematic of another embodiment of actuator mechanism of FIG. 8 constructed in accordance with the present disclosure;

FIG. 11 is a schematic of another embodiment of the actuator mechanism of the selectable clutch module constructed in accordance with the present disclosure;

FIG. 12 is a schematic of another embodiment of the actuator mechanism of FIG. 11 constructed in accordance with the present disclosure; and

FIG. 13 is a schematic of another embodiment of the actuator mechanism of FIG. 11 constructed in accordance with the present disclosure.

It is to be noted that the appended drawings illustrate only typical embodiments and are therefore not to be considered limiting with respect to the scope of the disclosure or claims. Rather, the concepts of the present disclosure may apply within other equally effective embodiments. Moreover, the drawings are not necessarily to scale, emphasis generally being placed upon illustrating the principles of certain embodiments.

### DETAILED DESCRIPTION

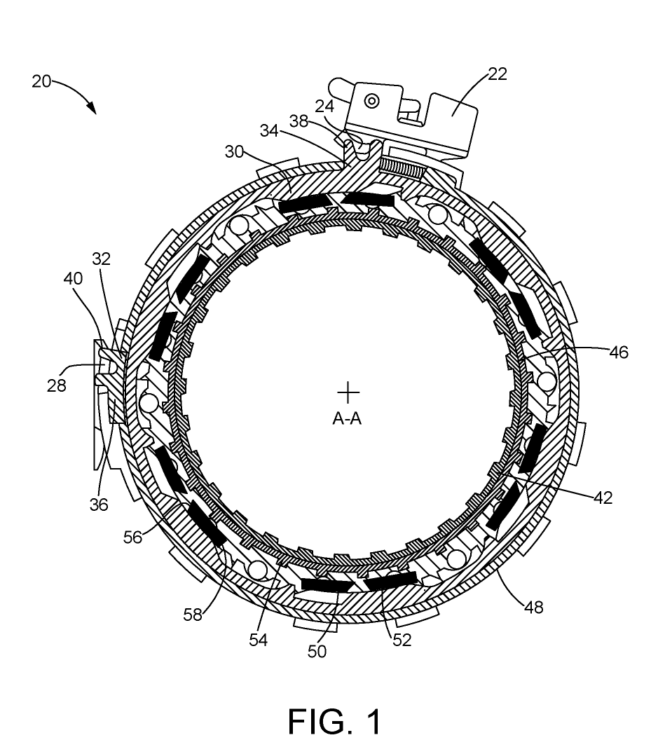

Turning now to the drawings, and with specific reference to FIG. 1, a selectable clutch module constructed in accordance with the present disclosure is generally referred to by reference numeral 20. One non-limiting example of the selectable clutch module 20 is illustrated as that of a multi-mode clutch. However it will be understood that the present disclosure may be applied to other types of selectable clutches. The selectable clutch module 20 is shown to include an actuator 22 having an armature 24. The actuator 22 may be a hydraulic actuator such as hydraulic over spring actuator, hydraulic over hydraulic actuator or other known types of actuators. Moreover, the armature 24 may be moved upon actuation by the actuator 22 and such actuation of the armature 24 may be utilized to control a plurality of modes of the selectable clutch module 20. In some embodiments, the selectable clutch module may include first and second armatures 24, 28 that may be utilized to control various components of the selectable clutch module 20. Moreover, the actuator 22 may be configured to actuate each of the first and second armatures 24, 28 as needed in the operation of the selectable clutch module 20.

The selectable clutch module 20 may also include a cam 30 that may be substantially circular in shape and configured to move or rotate with respect to an axis A-A. In some embodiments, the cam 30 may have a cam arm 34 that is rigidly attached to the cam 30. However, other attachment configurations may be possible. A cam arm face 38 may be located on the cam arm 34, and in some embodiments the cam arm face 38 may be u-shaped and configured to mate with the armatures 24. However, other shapes and configurations of the cam arm face 38 are possible. In one exemplary embodiment, actuation of the actuator 22 may cause the armature 24 to impinge upon the cam arm face 38. This impingement may cause the cam arm 34 to move. Accordingly, as the cam arm 34 may be rigidly attached to the cam 30, a movement of the cam arm 34 may produce a corresponding motion or rotation of the respective cam 30. In this manner, the cam arm 34 and the cam 30 may responsively move based on the motion of the actuator 22 and the armatures 24.

Additionally or alternatively, the selectable clutch module 20 may be configured with more than one cam 30. For example, the selectable clutch module 20 may include a first cam 30 and a second cam 32 and the first and second cams 30, 32 may be configured such that they are independent from one another. Moreover, the first and second cams 30, 32 may be substantially circular in shape and configured to independently move or rotate with respect to one another about the axis A-A. In some embodiments, the first cam 30 may have a first cam arm 34 and the second cam 32 may have a second cam arm 36. Moreover, in one non-limiting example the first and second cam arms 34, 36 may be rigidly attached to the first and second cams 30, 32; however other attachment configurations may be possible. A first cam arm face 38 may be located on the first cam arm 34; a second cam arm face 40 may be located on the second cam arm 36. In some embodiments the first and second cam arm faces 38, 40 may be u-shaped and configured to mate with the first and second armatures 24, 26, however other shapes and configurations of the cam arm faces 38, 40 are possible. In one exemplary embodiment, the actuator 22 may be configured to actuate both the first and second cams 30, 32. For example, the first and second cams 30, 32 may be configured such that actuation of the actuator 22 may cause the armature 24 to impinge upon the first and second cam arm faces 38, 40. This impingement may cause the first and second cam arms 34, 36 to move. Accordingly, as the cam arms 34, 36 may be rigidly attached to the cams 30, 32; a motion of the cam arms 34, 36 may produce a corresponding motion or rotation of the respective cams 30, 32. In this manner, the cam arms 34, 36 and the cams 30, 32 may responsively move to the motion of the actuator 22, and the armatures 24, 28.

The selectable clutch module 20 may also include a rotatable driven hub 42 and an outer housing (not shown). The driven hub 42 may be adapted to secure a rotatable driving member 46 or inner race. Moreover, the selectable clutch module 20 may have a driven member 48 or outer race that is positioned and configured as a non-rotatable member. During operation, the first and second cams 30, 32 may be disposed between the driving member 46 and the driven member 48 and configured to rotate over a predetermined angle about the common axis A-A of the driven hub 42. In some embodiments, the angular rotation of the cams 30, 32 may be utilized to control one or more movements of at least one pair of opposed pawls 50, 52. In one non-limiting example, the driving member 46 may include a series of notches 54. In operation, the opposed pairs of pawls 50, 52 may rotate or otherwise move between an open position, a locked position, or any other desired position. Moreover, the opposed pairs of pawls 50, 52 may be shaped or otherwise formed to have a toe portion 56 and a heel portion 58. In an open position, the opposed pairs of pawls 50, 52 may allow the driving member 46 to rotate in a particular direction, or both directions. Additionally, or alternatively, when placed in a locked position the opposed pairs of pawls 50, 52 may restrict rotation of the driving member 46 in a particular direction due to interference between one of the pawls 50, 52 and the notches 54. In some embodiments the locked position may also be referred to as a ratcheting position. More specifically, in the locked position the toe portion 56 of the pawls 50, 52 may interfere with a notch 54 of the driving member 46, thus preventing the driving member 46 rotating in a particular direction.

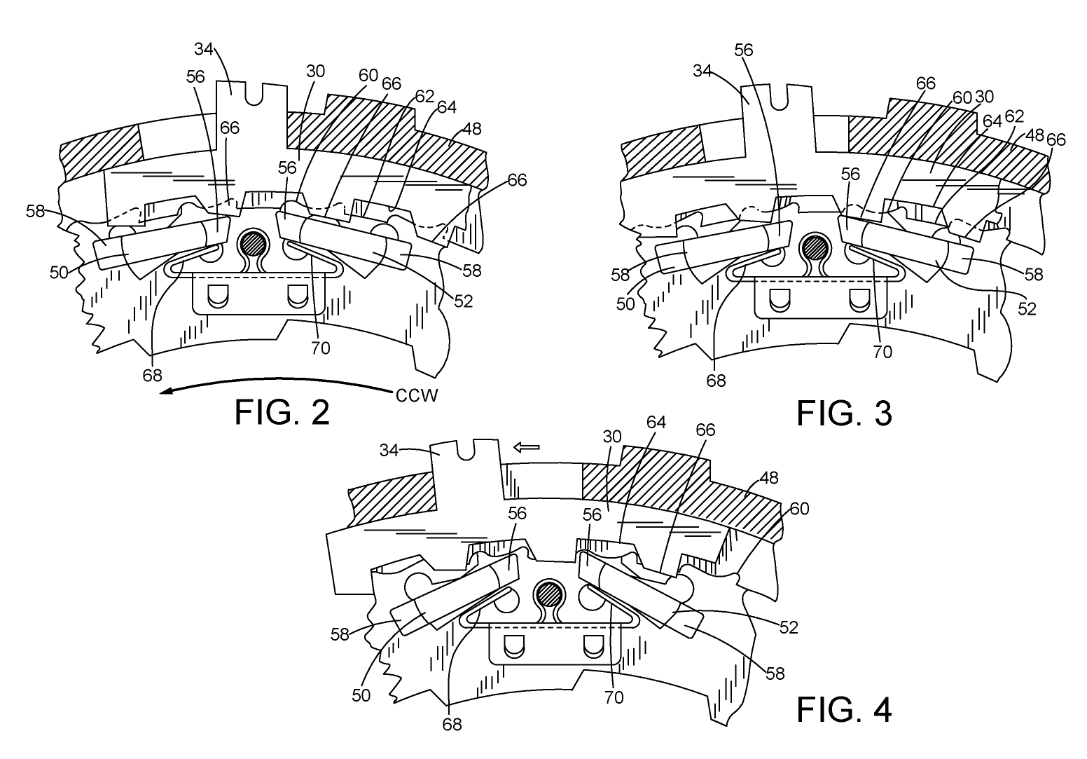

A portion of the operational components of the selectable clutch module 20 are further illustrated in FIGS. 2-4 and provide non-limiting examples of the various operational modes of the selectable clutch module 20. Looking first at FIG. 2, the driven member 48, or outer race may be configured to accommodate interactions with the pawls, 50, 52 by providing the inner circumference of the driven member 48 with circumferentially spaced notches 60 each defined by and positioned between pairs of radially inwardly projecting cogs 62. The notches 60 and cogs 62 may be configured such that, in the absence of the cam 30, a toe portion 56 of each pawl 50, 52 may enter one of the notches 60 and is engaged by the corresponding cog 62.

Moreover, FIG. 2 shows cam arm 34 positioned by the actuator 22 (FIG. 1) and the cam arm 34 in a first, angularly rightward selectable position, representative of a first mode of the selectable clutch module 20. In some embodiments, this position of the cam arm 34 may be representative of a first one-way locked, one way unlocked mode or open mode, however other positions and/or modes may be possible. In this configuration the slots 64 and teeth 66 of the cam 30 may be positioned such that the toe portions 56 of the pawls 50 may be blocked by the cam teeth 66 from engagement with the notches 54, and hence with the cogs 62 on the interior of the driven member 48. As such, the driving member 46 may be enabled to freewheel relative to the driven member 48, and to thus provide for an overrunning condition when the driving member 46 and the driven hub 42 are rotating clockwise relative to the driven member 48. Conversely, however, the position of the cam 30 may allow the toe portions 56 of the pawls 52 to enter the cam slots 64 due to the biasing force of the spring arms 70, and to thereby directly engage the cogs 62 of the driven member 48 to lock the driving member 46 and the driven member 48 together whenever the driving member 46 and the driven hub 42 undergo a driving, or counterclockwise rotational movement, thereby causing the driven hub 42 and the outer housing (not shown) to rotate together.

FIG. 3 shows the cam arm 34 positioned by the actuator 22 (FIG. 1) in a second, intermediate selectable position, representative of a two-way unlocked or open mode of the selectable clutch module 20. In this position and/or mode, the cam slots 64 and cam teeth 66 may be positioned such that the toe portions 56 of both pawls 50, 52 are blocked from the cam slots 64 in order to maintain disengagement from the cogs 62 of the driven member 48. With the pawls 50, 52 blocked from engagement with the cogs 62, the driving member 46 and the driven hub 42 are enabled to freewheel relative to the driven member 48 and the outer housing (not shown) during relative rotation in either the clockwise or the counterclockwise direction.

FIG. 4 illustrates the cam arm 34 positioned by the actuator 22 (FIG. 1) in a third, angularly leftward selectable position, representative of a two-way locked mode of the selectable clutch module 20. In this position and/or mode, the cam 30 may be positioned such that the toe portions 56 of the pair of pawls 50, 52 enter the cam slots 64 under the biasing forces of the spring arms 68, 70, respectively, and are engaged by the cogs 62 of the driven member 48 as described above to lock the driving member 46 and the driven hub 42 to the driven member 48 and the outer housing (not shown) for rotation therewith, irrespective of the rotational direction of the driving member 46 and the driven hub 42.

Even though one specific embodiment of the selectable clutch module 20 is illustrated and described herein, those skilled in the art will understand that alternative configurations of selectable clutches are possible that may provide operational modes or positions as alternatives or in addition to two-way unlocked and two-way locked modes (FIGS. 3 and 4), and the one way locked, one-way unlocked mode (FIG. 2). For example, an additional one-way locked, one-way unlocked mode that may provide for an overrunning condition when the driving member 46 and the driven hub 42 are rotating counterclockwise relative to the driven member 48 and the outer housing (not shown), and to lock the driving member 46 and the driven member 48 together whenever the driving member and the driven hub 42 undergo a clockwise rotational movement so the driven hub 42 and the outer housing (not shown) rotate together.

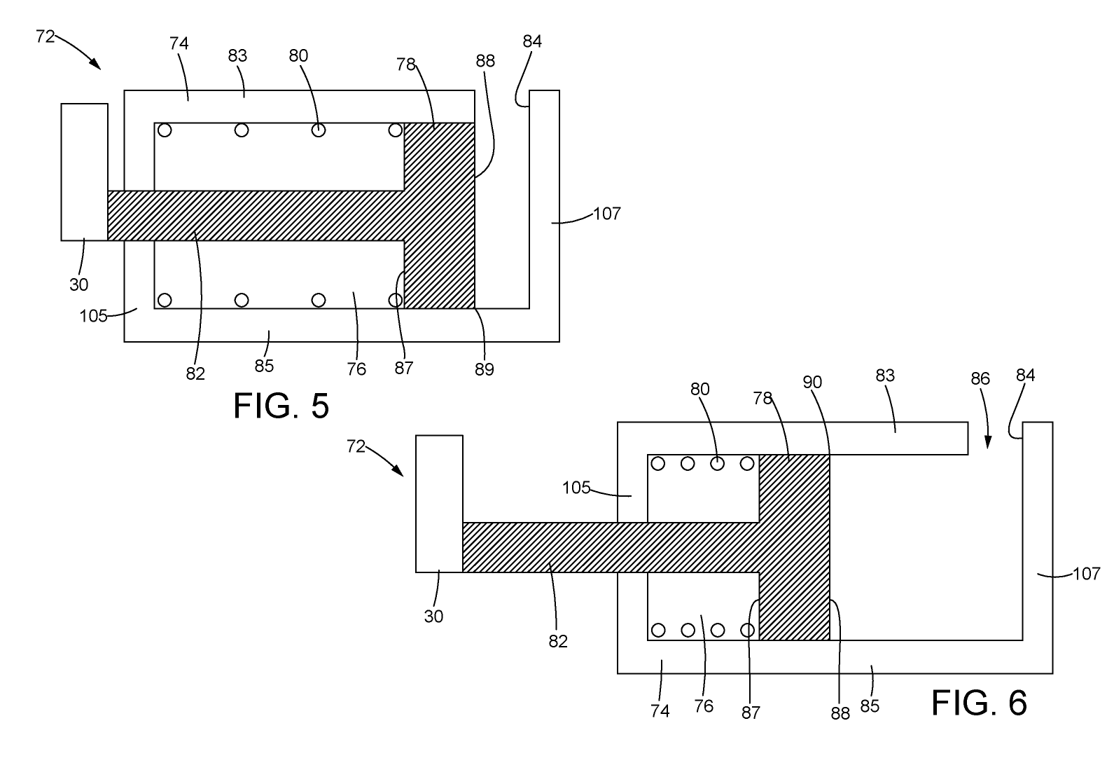

FIG. 5 illustrates one non-limiting example of an actuating mechanism 72 that may be used as the actuator 22 (FIG. 1) of the selectable clutch module 20. In some embodiments, the actuating mechanism 72 may incorporate a hydraulic piston against a spring to achieve three or more modes of operation of the selectable clutch module 20. Moreover, the selectable clutch module 20 may be configured to use a single actuator and a single hydraulic source to actuate one or two cams. As discussed in more detail below, the actuating mechanism 72 may provide an actuator that uses a hydraulic piston against a spring to achieve multiple modes using a single actuator and a single hydraulic source. As the piston moves, a mode of the selectable clutch module 20 may be changed by increasing the hydraulic pressure until the desired movement and mode are reached. The hydraulic force generated from the applied pressure against the piston may correlate with a spring rate or spring force of an actuator spring. As a result, a known hydraulic pressure may be applied against the piston to generate an amount of hydraulic force that moves the piston a desired length. Therefore, by knowing the spring rate and the pressure being applied it may be possible to selectably control the piston stroke of the actuator to produce one or more operational modes of the selectable clutch module 20.

FIG. 5 shows the actuating mechanism 72 in a first or default mode where there may be little or no hydraulic pressure applied. The actuating mechanism may have an actuator housing 74 that defines an actuator chamber 76. In some embodiments, the actuator chamber 76 may be configured to house a piston 78, an actuator spring 80 and an armature 82. Moreover, the piston 78 may be slidably engaged with a first lateral sidewall 83 and a second lateral sidewall 85 of the actuator housing 74. In some embodiments, the armature 82 is fixedly attached to a first surface 87 of the piston 78 and will respond to movements of the piston 78. Furthermore, the actuator spring 80 may be disposed in the actuator chamber 76 and the actuator spring 80 may be positioned between a first axial end 105 of the actuator housing 74 and the first surface 87 of the piston 78. Moreover, the armature 82 may be configured to impinge on the cam 30 and/or in some cases a plurality of cams 30, 32. The actuator housing 74 may include a hydraulic opening 84 positioned adjacent to a second axial end 107 of the actuator housing 74, however other locations of the hydraulic opening 84 may be possible. The hydraulic opening 84 may be configured to allow the external environment to communicate with the actuator chamber 76. As illustrated in FIG. 5 a default position of the piston 78 may place the piston 78 at a first position 89. In some embodiments, the first position 89 of the piston 78 may correspond to a first mode of operation of the selectable clutch module 20.

FIGS. 5-7 illustrate non-limiting examples of the actuating mechanism 72 that may correspond to one or more operating modes of the selectable clutch module 20. In some embodiments, a hydraulic pressure 86 may be selectively applied to the actuating mechanism 72. The hydraulic pressure 86 may be a controlled pressure that is provided by a system controller mechanism (not shown). Additionally or alternatively, the hydraulic pressure 86 may be an uncontrolled pressure and may be a line pressure or pressure feed from another area of the system. The hydraulic pressure 86 is supplied to the hydraulic opening 84 and it may enter the actuator chamber 76 where it will act upon a second surface 88 of the piston 78. In some embodiments, the hydraulic pressure 86 interaction with the second surface 88 of the piston 78 may create a movement of the piston 78. Moreover, when the piston 78 is in the first position 89 the hydraulic pressure 86 may be very low or not high enough to produce a force greater than the spring force of the actuator spring 80.

More specifically, in one non-limiting example illustrated in FIG. 6, the hydraulic pressure 86 is supplied to the actuator housing hydraulic opening 84 such that the hydraulic pressure 86 is directed into the actuator chamber 76 and may act upon the second surface 88 of the piston 78. In some embodiments, the hydraulic pressure 86 may move the piston 78 from the piston first position 89 to a piston second position 90. In some embodiments, the piston second position 90 may correspond to a second operational mode of the selectable clutch module 20. Additionally, as the piston 78 moves from the piston first position 89 to the piston second position 90, the actuator spring 80 may compress along with the movement of the piston 78. In some embodiments, the piston 78 may continue to move until a force generated by the hydraulic pressure 86 is balanced or equalized with the spring force of the actuator spring 80.

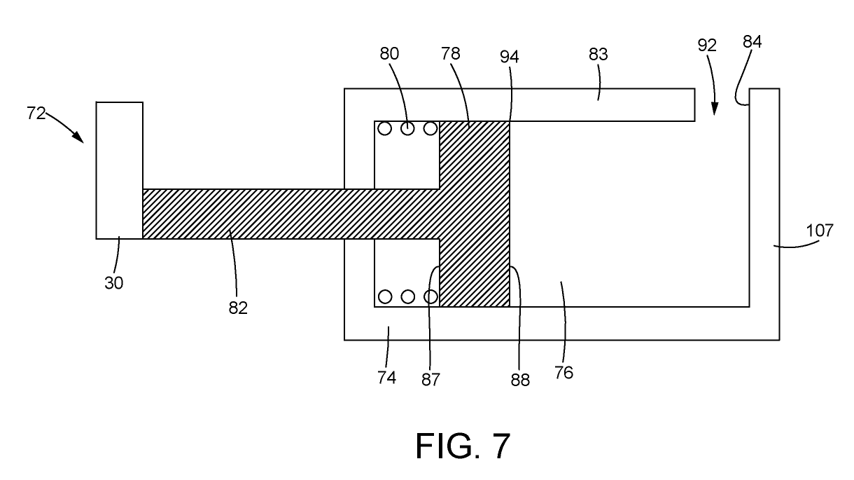

Moreover, FIG. 7 illustrates one non-limiting example where the hydraulic pressure 86 is increased to a second hydraulic pressure 92. As a result of the increased second hydraulic pressure 92, the force acting on the second surface 88 of the piston 78 may be larger than the spring force of the actuator spring 80 and therefore cause in increase in the compression of the actuator spring 80 such that the piston 78 is moved to a third position 94. In some embodiments, the piston third position may correspond to a third operational mode of the selectable clutch module 20. As described above, the increased second hydraulic pressure 92 may continue to cause the piston 78 to move until the spring force of the actuator spring 80 and the force generated from the second hydraulic pressure 92 are balanced or equalized. Moreover, as shown in FIGS. 5-7, the first, second, and third piston positions 89, 90, 94 may have a corresponding effect on the armature 82, such that as the piston moves there is a corresponding movement of the armature 82 and the cam 30.

Although FIGS. 5-7 illustrate three different modes of the selectable clutch module 20 it will be recognized by one skilled in the art that additional modes may be possible by applying different pressures and spring rates to the actuating mechanism 72. Moreover, the non-limiting examples shown in FIGS. 5-7 may produce a substantially linear relationship between the pressure applied and actuator position. As a result, different actuator springs 80 having different spring forces may be substituted to provide alternate amount of movement and position of the piston 78 for a given pressure supplied to the actuating mechanism 72.

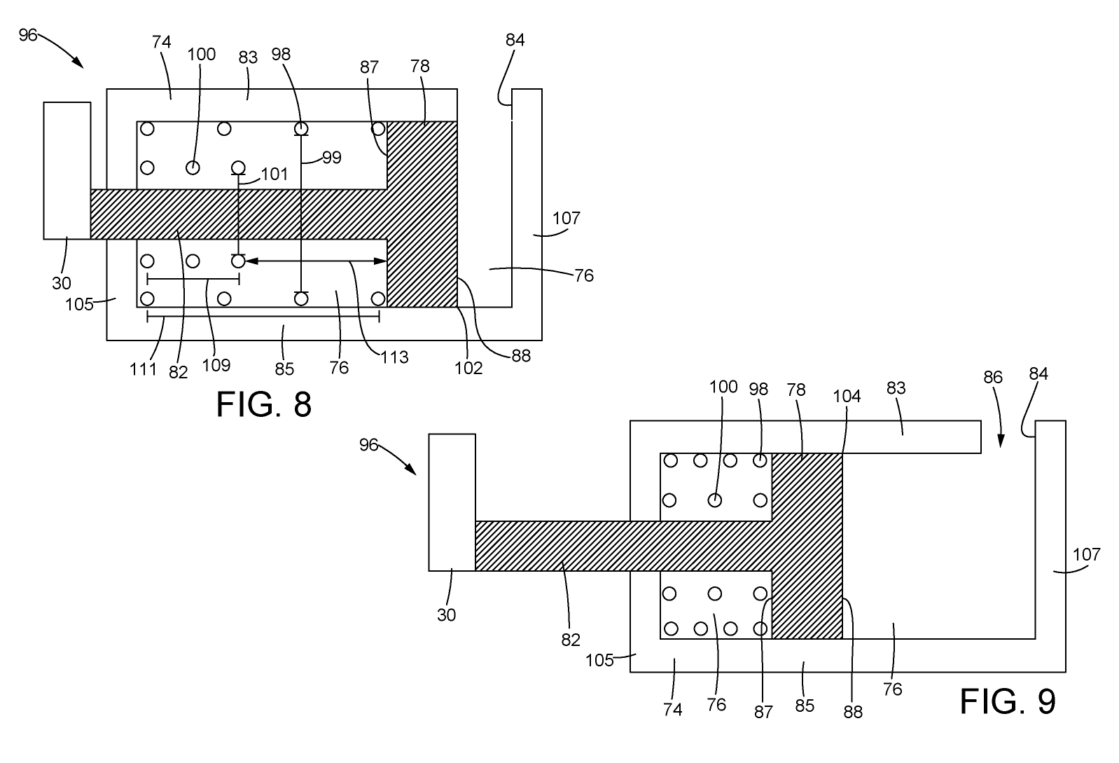

FIG. 8 provides one non-limiting example of an alternative actuating mechanism 96 that may be used as the actuator 22 of the selectable clutch module 20. In some embodiments, the actuating mechanism 96 may incorporate a hydraulic piston against a spring to achieve three or more modes of operation of the selectable clutch module 20. The actuating mechanism 96 may have an actuator housing 74 that defines an actuator chamber 76. In some embodiments, the actuator chamber 76 may be configured to house a piston 78, a first actuator spring 98 having a first spring diameter 99 and a second actuator spring 100 having a second spring diameter 101. Moreover, the actuator chamber 76 may further include an armature 82 that is surrounded by both the first actuator spring 98 and the second actuator spring 100. In one non-limiting example, the first actuator spring 98 is disposed within the actuator chamber 76 and the first actuator spring 98 is positioned between the first axial end 105 of the actuator housing 74 and the first surface 87 of the piston 78. Furthermore, the second spring diameter 101 of the second actuator spring 100 may be sized such that the second spring diameter 101 is smaller than the first spring diameter 99 of the first actuator spring 98. As a result, the second actuator spring 101 may be placed inside of the first spring diameter 99 of the first actuator spring 98. Additionally, the second actuator spring 101 may have an uncompressed height 109 that is shorter than the uncompressed height 111 of the first actuator spring 98.

In some embodiments, the armature 82 is fixedly attached to the first surface 87 of the piston 78 and will respond to movements of the piston 78. Moreover, the armature 82 may be configured to impinge on the cam 30 and/or in some cases a plurality of cams 30, 32. The actuator housing 74 may further include a hydraulic opening 84 that communicates with the actuator chamber 76. As illustrated in FIG. 8, when the first actuator spring 98 and the second actuator spring 100 are both in an uncompressed state, the piston 78 may be in a piston first position 102 that corresponds to a first mode of operation of the selectable clutch module 20. Moreover, in the piston first position 102, the first and second actuator springs 98, 100 may be arranged such that only one of the actuator springs 98, 100 may be engaged with the piston 78. For example, as illustrated in FIG. 8, when the piston 78 is in the piston first position 102, one end of the first actuator spring 98 is in direct contact with first axial end 105 of the actuator housing 74 and the other end of the first actuator spring 98 is in direct contact with the first surface 87 of the piston 78. Whereas, one end the second actuator spring 100 may be in direct contact with the first axial end 105 of the actuator housing 74 and the other end of the second actuator spring 100 may be a distance 113 away from the first surface 87 of the piston 78.

FIGS. 8-10 illustrate non-limiting examples of the actuating mechanism 96 that may correspond to one or more operating modes of the selectable clutch module 20. In some embodiments, a hydraulic pressure 86 may be selectively applied to the actuating mechanism 96. The hydraulic pressure 86 may be a controlled pressure that is provided by a system controller mechanism (not shown). Additionally or alternatively, the hydraulic pressure 86 may be an uncontrolled pressure and may be a line pressure or pressure feed from another area of the system. The hydraulic pressure 86 is supplied to the hydraulic opening 84 and it may enter the actuator chamber 76 where it will act upon a piston surface 88. In some embodiments, the hydraulic pressure 86 interaction with the piston surface 88 may create a movement of the piston 78.

In one non-limiting example illustrated in FIG. 9, the hydraulic pressure 86 is supplied to the actuator housing hydraulic opening 84 such that the hydraulic pressure 86 is directed into the actuator chamber 76 and the hydraulic pressure 86 may act upon the second surface 88 of the piston 78. In some embodiments, the hydraulic pressure 86 may move the piston 78 from the piston first position 102 to a piston second position 104, and the piston second position 104 may correspond to a second operational mode of the selectable clutch module 20. In some embodiments, the hydraulic pressure 86 may cause the piston 78 to continue to move until the force generated by the hydraulic pressure 86 is balanced or equalized with the spring force of the first actuator spring 98. Additionally or alternatively, the piston 78 may continue to move until the first actuator spring 98 is compressed the distance 113 (FIG. 8) and the second actuator spring 100 comes into direct contact with the piston 78. As a result, both the first and second actuator springs 98, 100 may be in direct contact with the first surface 87 of the piston 78. If the spring force added by the second actuator spring 100 is greater than the force being generated by the hydraulic pressure 86 then the piston 78 may stop at the second mode once the second actuator spring 100 comes into contact with the piston 78. Conversely, if the spring force added by the second actuator spring 100 is less than the force generated by the hydraulic pressure 86 then the piston 78 may continue to move until the sum of the spring force of the first and second actuator springs 98, 100 is balanced or equalized with the force generated by the hydraulic pressure 86.

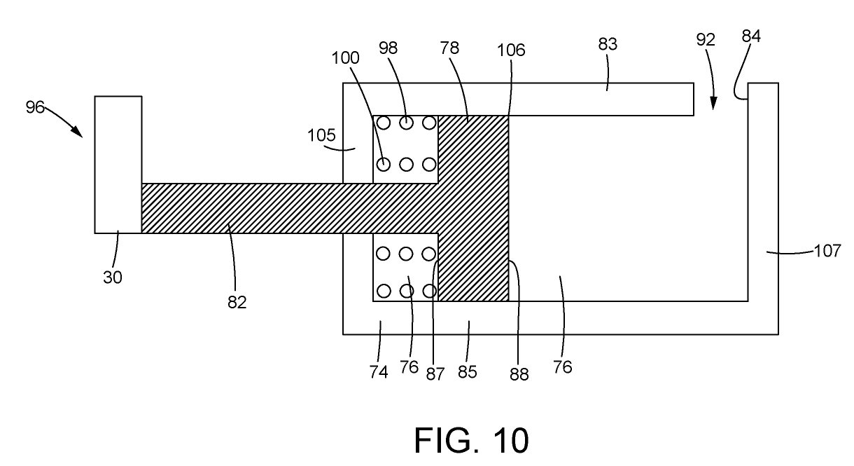

Moreover, FIG. 10 illustrates one non-limiting example where the hydraulic pressure 86 is increased to a second hydraulic pressure 92. As a result of the increased second hydraulic pressure 92, the force acting on the second surface 88 of the piston 78 may be larger than the sum of the spring forces of the first and second actuator springs 98,100 and therefore cause in increase in the compression of the springs 98, 100 such that the piston 78 is moved to a piston third position 106. In some embodiments, the piston third position 106 may correspond to a third operational mode of the selectable clutch module 20. As described above, the increased second hydraulic pressure 92 may continue to cause the piston 78 to move until the spring forces of the first and second actuator springs 98, 100 and the force generated from the second hydraulic pressure 92 are balanced or equalized. Moreover, as shown in FIGS. 8-10, the first, second and third positions 102, 104, 106 of the piston 78 may have a corresponding effect on the armature 82, such that as the piston 78 moves there is a corresponding movement of the armature 82 and the cam 30.

Although FIGS. 8-10 illustrate three different possible operational modes of the selectable clutch module, it will be recognized by one skilled in the art that additional modes may be possible by applying different pressures and spring rates to the actuating mechanism 96. Moreover, the non-limiting examples shown in FIGS. 8-10 which incorporate at least two actuator springs may produce a non-linear relationship between the applied hydraulic pressure and actuator position. Furthermore, incorporating first and second actuator springs 98, 100 may increase the spring force once a particular mode is reached. For example, the first actuator spring 98 may provide a relationship between the applied pressure and piston position as having a first slope and the second actuator spring 100 may provide a relationship between the applied pressure and piston position as having a second slope. As a result, the controllability of the system may be improved and a reduced spring force may be utilized to select between different positions or modes of the selectable clutch module 20.

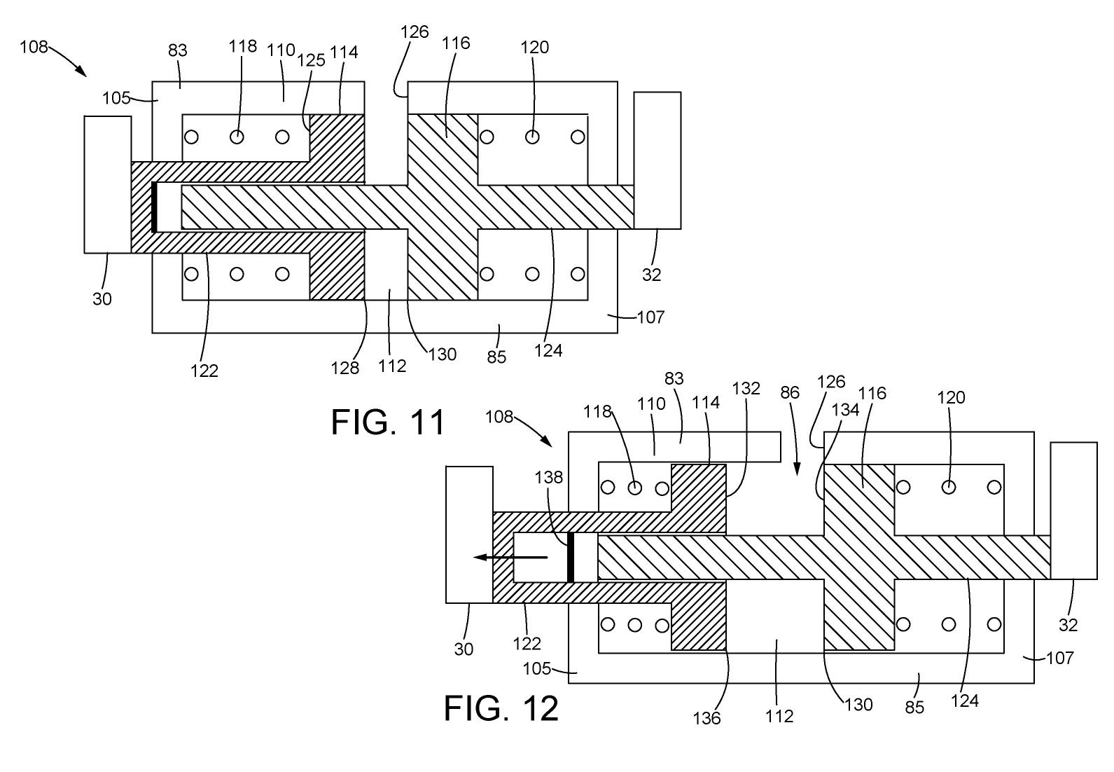

FIG. 11 provides an additional non-limiting example of an actuating mechanism 108 that be configured to actuate more than one cam, such as the first and second cams 30, 32 (FIG. 1), and may be used as the actuator 22 of the selectable clutch module 20 (FIG. 1). In some embodiments, the actuating mechanism 108 may incorporate a plurality of hydraulic pistons against a plurality of springs to achieve three or more modes of operation of the selectable clutch module 20. The actuating mechanism 108 may have an actuator housing 110 that defines an actuator chamber 112. In some embodiments, the actuator chamber 112 may be configured to house a first piston 114, a second piston 116, a first actuator spring 118, a second actuator spring 120, a first armature 122 and a second armature 124. In some embodiments, the first armature 122 is fixedly attached to a first surface 125 of the first piston 114 and will respond to movements of the first piston 114. The second armature 124 may be fixedly attached to first surface 127 of the second piston 116 and will respond to movements of the second piston 116. Moreover, the armatures 122, 124 may be configured to impinge on the cams 30, 32 of the selectable clutch module 20 (FIG. 1). The actuator housing 110 may further include a hydraulic opening 126 that is positioned between the first and second pistons 114, 116. Moreover, the hydraulic opening 126 may be configured to communicate between an exterior environment of the actuator housing 110 and the actuator chamber 112. As illustrated in FIG. 11 the first piston 114 may be in a first piston first position 128 and the second piston 116 may be in a second piston first position 130 that correspond to a first mode of operation of the selectable clutch module 20.

FIGS. 11-13 illustrate non-limiting examples of the actuating mechanism 108 that may be configured to act upon two cams. Similar to actuating mechanisms 72, 96, some embodiments may use a hydraulic pressure 86 that is selectively applied to the actuating mechanism 108. The hydraulic pressure 86 may be a controlled pressure that is provided by a system controller mechanism (not shown). Additionally or alternatively, the hydraulic pressure 86 may be an uncontrolled pressure and may be a line pressure or pressure feed from another area of the system. The hydraulic pressure 86 is supplied to the hydraulic opening 126 and it may enter the actuator chamber 112 where it may interact with a second surface 132 of the first piston 114 and a second surface 134 of the second piston 116. In some embodiments, the hydraulic pressure 86 interaction with the piston surface 88 may create a movement of the piston 78. As illustrated in FIG. 11 no hydraulic pressure 86 is supplied to the actuating mechanism 108 and the pistons 114, 116 are in their respective first positions 128, 130.

In one non-limiting example illustrated in FIG. 12, the hydraulic pressure 86 is supplied to the actuator housing hydraulic opening 126 such that the hydraulic pressure 86 is directed into the actuator chamber 112 and may interact with the a second surface 132 of the first piston 114 and the second surface 134 of the second piston 116. In some embodiments, the hydraulic pressure 86 may generate enough force to move the first piston 114 to a first piston second position 136 while the second piston 116 does not move and remains in the second piston first position 130. The hydraulic pressure 86 may move the first piston 114 from its first piston first position 128 to its first piston second position 136 because the force generated by the hydraulic pressure when it enters the actuator chamber 112 is greater than the spring force of the first actuator spring 118. Conversely, the second piston may not move from its corresponding first position 130 because the force generated by the hydraulic pressure 86 entering the actuator chamber is less than the spring force of the second actuator spring 120. As a result, the movement of the first piston 114 may cause the first armature 122 to move and cause a corresponding actuation of the cam 30. Moreover, there may be a vent 138 that is present in the actuator housing 110 that allows the actuating mechanism 108 to vent during operation and the vent 138 may provide a vent pathway for the hydraulic pressure 86 supplied to the actuator chamber 112.

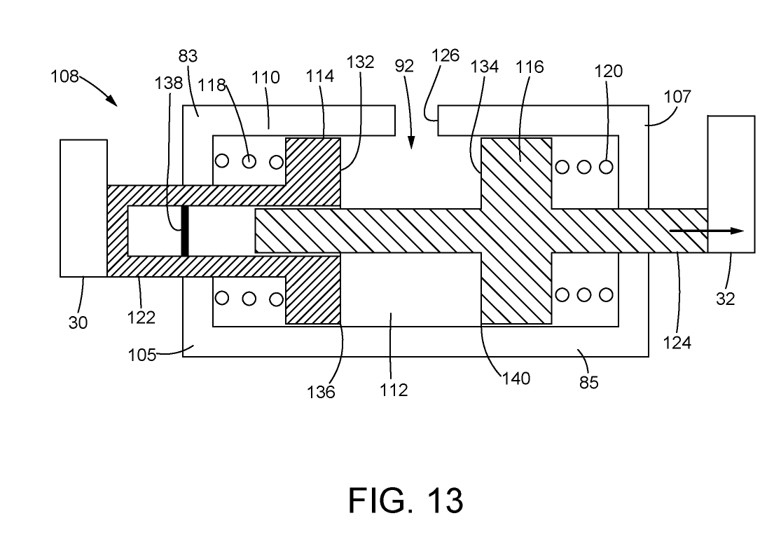

Moreover, FIG. 13 illustrates one non-limiting example associated with another mode of operation of the selectable clutch module 20 where the hydraulic pressure 86 may be increased to a second hydraulic pressure 92. As a result of the increased second hydraulic pressure 92, the force acting on the first and second piston surfaces 132, 134 may be larger than both of the spring forces of the first and second actuator springs 118, 120. Therefore the first piston 114 may stay at the first piston second position 136, or the second hydraulic pressure 92 may move the first piston 114 to a first piston third position (not shown). Moreover, the second hydraulic pressure 92 may generate a force that is greater than the spring force of the second actuator spring 120, and the second piston 116 may move to a second piston second location 140. In some embodiments, movement of the first and second pistons 114, 116 to their respective second piston positions 136, 140 may correspond to a third operational mode of the selectable clutch module 20. Furthermore, as described above, the increased second hydraulic pressure 92 may create a force that acts upon the first and second piston surfaces 132, 134 which cause the first and second pistons 114, 116 to move until the spring forces of the first and second actuator springs 118, 120 and the force generated from the second hydraulic pressure 92 are balanced or equalized. Moreover, as shown in FIGS. 11-13, the piston positions 128, 130, 136, 140 may have a corresponding effect on the armature 82, such that as the piston 78 moves there is a corresponding movement of the armatures 122, 124 and the cams 30, 32.

Although FIGS. 11-13 illustrate three different modes of the selectable clutch module, it will be recognized by one skilled in the art that additional modes may be possible by applying different pressures and spring rates to the actuating mechanism 96. Moreover, the non-limiting examples shown in FIGS. 11-13 which incorporate at plurality of pistons and a plurality of actuator springs which produce a non-linear relationship between the pressure applied and actuator position. For example, the first actuator spring 118 may provide a relationship between pressure and piston position as having a first slope and the second actuator spring 120 may provide a relationship between the pressure and piston position as having a second slope. Furthermore, if one of the first and/or second actuator springs 118, 120 is preloaded it may allow a position or mode such as the second position or mode to be reached over an expanded range of pressures. The resulting pressure versus position profile may create a stepped profile and such a pressure profile may allow for some tolerance in the system as the selectable clutch module is switches between modes.

It is to be understood that the foregoing is a description of one or more embodiments of the invention. However, the invention is not limited to the particular embodiment(s) disclosed herein. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

### INDUSTRIAL APPLICABILITY

In general, the selectable clutch of the present disclosure may be applied in a variety of industrial applications, including but not limited to, automobiles, trucks, vans, off-road vehicles, agriculture equipment, construction equipment, and other equipment of the type incorporating internal combustion engines, automatic transmissions, and drivelines.

As disclosed herein, the selectable clutch may be a multi-mode clutch module, or other such clutch, and the selectable clutch may incorporate an actuator that can be used to control the selectable clutch module between three or more operational modes. Furthermore, the selectable clutch module may be adaptable to allow use with both new transmission applications as well as with an existing transmission architecture where there may be only one controlled pressure feed. Additionally or alternatively, the selectable clutch module of the present disclosure may allow for independent control of the forward and reverse acting cams. In some embodiments, an actuator such as hydraulic against a spring actuator, hydraulic over hydraulic actuators and/or other known actuators may allow a selectable clutch achieve three or more modes using a single actuator and a single hydraulic source. Furthermore, such a selectable clutch module may be configured to actuate one or more cams. In some embodiments, the hydraulic force generated from the applied pressure may correlate to a stroke length of the actuator based on the actuator spring force or spring rate. As a result, knowing the spring rate or force and the pressure being applied may allow for a specific clutch mode to be selected. Such a selectable clutch module may be applied to existing transmission applications with minimal tear up such as with the replacement of a low reverse clutch where a single hydraulic feed already exists.

What is claimed is:

1. An actuating mechanism for a selectable clutch module, the actuating mechanism comprising:
an actuator housing defining an actuator chamber;
a piston disposed within the actuator chamber, the piston slidably engaged with a first lateral sidewall and a second lateral sidewall of the actuator housing such that the piston is configured to move along the first and second lateral sidewalls between at least a first piston position and a second piston position;
an armature fixedly attached to a first surface of the piston such that the armature is configured to respond to a movement of the piston;
a cam operatively associated with the armature;
an actuator spring disposed within the actuator chamber, the actuator spring positioned between the first surface of the piston and a first end of the actuator housing;
a hydraulic opening formed in the actuator housing, the hydraulic opening extending through the actuator housing into the actuator chamber and the hydraulic opening positioned at a second end of the actuator housing; and
a hydraulic pressure being supplied to the actuating mechanism through the hydraulic opening, the hydraulic pressure is configured to act on a second surface of the piston such that the piston moves between the at least first piston position and the second piston position.

2. The actuating mechanism of claim 1, further comprising a controller configured to selectably control the hydraulic pressure supplied to the actuating mechanism, wherein the actuator spring is configured with a known spring force and the controller provides a first pre-determined amount of the hydraulic pressure based on the known spring force, and wherein the first pre-determined amount of the hydraulic pressure is configured to act on the second surface of the piston and move the piston from the first piston position to the second piston position.

3. The actuating mechanism of claim 2, wherein the controller provides a second pre-determined amount of the hydraulic pressure based on the known spring force, and wherein the second pre-determined amount of the hydraulic pressure is configured to act on the second surface of the piston to further move the piston from the second piston position to a third piston position.

4. The actuating mechanism of claim 1, further comprising a second actuator spring disposed within the actuator chamber, the second actuator spring positioned between the first end of the actuator housing and a distance away from the first surface of the piston, wherein the actuator spring has a first diameter and the second actuator spring has a second diameter that is smaller than the first diameter such that the second actuator spring is placed inside the first diameter of the actuator spring.

5. The actuating mechanism of claim 4, further comprising a controller configured to selectably control the hydraulic pressure supplied to the actuating mechanism, wherein the actuator spring is configured with a known first spring force and the second actuator spring is configured with a known second spring force and the controller provides a pre-determined first hydraulic pressure based on the known first spring force and the known second spring force, and wherein the pre-determined first hydraulic pressure is configured to act on the second surface of the piston to move the piston from the first piston position to the second piston position, and wherein the pre-determined first hydraulic pressure is greater than the first spring force and less than the second spring force such that the piston moves from the first piston position to the second piston position and the piston stops when the first surface of the piston comes in contact with the second actuator spring.

6. The actuating mechanism of claim 5, wherein the controller provides a pre-determined second hydraulic pressure based on the known first spring force and the known second spring force, and wherein the pre-determined second hydraulic pressure is greater than a sum of the first spring force and the second spring force such that the pre-determined second hydraulic pressure is configured to act on the second surface of the piston to move the piston from the second piston position to a third piston position.

7. An actuating mechanism for a selectable clutch, the actuating mechanism comprising:
an actuator housing defining an actuator chamber;
a first piston and a second piston disposed within the actuator chamber, the first piston and the second piston slidably engaged with a first lateral sidewall and a second lateral sidewall of the actuator housing, the first piston configured to move along the first and second lateral sidewalls between at least a first piston first position and a first piston second position, and the second piston configured to move in an opposite direction as the first piston along the first lateral sidewall and the second lateral sidewall between at least a second piston first position and a second piston second position;
a first armature fixedly attached to a first surface of the first piston such that the first armature is configured to respond to a movement of the first piston;
a second armature fixedly attached to a first surface of the second piston such that the second armature is configured to respond to a movement of the second piston;
a first cam operatively associated with the first armature and a second cam operatively associated with the second armature;
a first actuator spring disposed within the actuator chamber, the first actuator spring positioned between the first surface of the first piston and a first axial end of the actuator housing;
a second actuator spring disposed within the actuator chamber, the second actuator spring positioned between the first surface of the second piston and a second axial end of the actuator housing;
a hydraulic opening formed in the actuator housing, the hydraulic opening extending through the actuator housing into the actuator chamber and the hydraulic opening positioned between the first piston and the second piston; and
a hydraulic pressure being supplied to the actuator chamber through the hydraulic opening, the hydraulic pressure is configured to act on a second surface of the first piston and a second surface of the second piston to move each of the first piston and the second piston.

8. The actuating mechanism of claim 7, further comprising a controller configured to selectably control the hydraulic pressure supplied to the actuating mechanism, wherein the first actuator spring is configured with a first spring force and the second actuator spring is configured with a second spring force equal to the first spring force, the controller provides a first pre-determined hydraulic pressure based on the first spring force and the second spring force, and wherein the first pre-determined hydraulic pressure is configured to act on the second surface of the first piston and the second surface of the second piston to compress both of the first and second actuator springs such that the first piston moves from the first piston first position to the first piston second position and the second piston moves from the second piston first position to the second piston second position.

9. The actuating mechanism of claim 8, wherein the first spring force of the first actuator spring is lower than the pre-determined first hydraulic pressure and the second spring force of the second actuator spring is greater than the pre-determined first hydraulic pressure, and wherein the pre-determined first hydraulic pressure is configured such that the first piston moves from the first piston first position to the first piston second position and the second piston remains in the second piston first position.

10. The actuating mechanism of claim 9, wherein the controller provides an additional pre-determined second hydraulic pressure greater than the pre-determined first hydraulic pressure and the pre-determined second hydraulic pressure is greater than both the first spring force of the first actuator spring and the second spring force of the second actuator spring, and wherein the pre-determined second hydraulic pressure is configured such that the first piston remains in the first piston second position and the second piston moves from the second piston first position to the second piston second position.

11. The actuating mechanism of claim 8, wherein at least one of the first actuator spring and the second actuator spring includes a preloaded spring, and the controller is configured to supply a pre-determined range of hydraulic pressure such that the preloaded spring allows at least one of the first piston and the second piston to move from the first piston first position to the first piston second position and the second piston first position to the second piston second position across the pre-determined range of hydraulic pressure.

12. A selectable clutch having a plurality of operational modes, the selectable clutch comprising:
an actuating mechanism configured to selectably actuate the selectable clutch between the plurality of operational modes, the actuating mechanism comprising:
an actuator housing defining an actuator chamber;
a piston disposed within the actuator chamber, the piston slidably engaged with a first lateral sidewall and a second lateral sidewall of the actuator housing such that the piston is configured to move along the first lateral sidewall and the second lateral sidewall between at least a first piston position and a second piston position;
an armature fixedly attached to a first surface of the piston such that the armature is configured to respond to a movement of the piston;
an actuator spring disposed within the actuator chamber, the actuator spring positioned between the first surface of the piston and a first axial end of the actuator housing;
a hydraulic opening formed in the actuator housing, the hydraulic opening extending through the actuator housing into the actuator chamber and the hydraulic opening positioned at a second axial end of the actuator housing and,
a hydraulic pressure being supplied to the actuating mechanism through the hydraulic opening, the hydraulic pressure configured to act on a second surface of the piston to move the piston between the at least first piston position and the second piston position;
a cam having a cam profile, the cam operably coupled to the armature wherein the cam is actuated based on a movement of the piston; and
at least one pair of opposing pawls, wherein the at least one pair of opposing pawls being able to rotate according to a position of the cam profile and the actuating mechanism configured to selectively actuate the cam to control the selectable clutch between the plurality of operational modes.

13. The selectable clutch of claim 12, further comprising a controller configured to selectably control the hydraulic pressure supplied to the actuating mechanism, wherein the actuator spring is configured with a known spring force and the controller provides a first pre-determined hydraulic pressure based on the known spring force, and wherein the first pre-determined hydraulic pressure is configured to act on the second surface of the piston and move the piston from the first piston position to the second piston position.

14. The selectable clutch of claim 13, wherein the controller provides a second pre-determined amount of the hydraulic pressure based on the known spring force, and wherein the second pre-determined amount of the hydraulic pressure is configured to act on the second surface of the piston to further move the piston from the second piston position to a third piston position.

15. The selectable clutch of claim 13, further comprising a second actuator spring disposed within the actuator chamber, the second actuator spring positioned between the first end of the actuator housing and a distance away from the first surface of the piston, wherein the actuator spring has a first diameter and the second actuator spring has a second diameter that is smaller than the first diameter such that the second actuator spring is placed inside the first diameter of the actuator spring, wherein the actuator spring is configured with the known spring force and the second actuator spring is configured with a known second spring force and the controller provides a pre-determined first hydraulic pressure based on the known spring force and the known second spring force, and wherein the pre-determined first hydraulic pressure is configured to act on the second surface of the piston to move the piston from the first piston position to the second piston position, and wherein the first pre-determined hydraulic pressure is greater than the known spring force and less than the known second spring force such that the piston moves from the first piston position to the second piston position and the piston stops when the first surface of the piston comes in contact with the second actuator spring.
